(19) United States
(12) Patent Application Publication
(10) Pub. No.: US 2015/0316167 A1
(43) Pub. Date: Nov. 5, 2015

(54) METHOD OF CONTROLLING A MICRO-ELECTRO-MECHANICAL SYSTEM (MEMS) VALVE

(71) Applicants: GM GLOBAL TECHNOLOGY OPERATIONS LLC, Detroit, MI (US); Microstaq Inc., Austin, TX (US)

(72) Inventors: Dongxu Li, Troy, MI (US); Chunhao J. Lee, Troy, MI (US); Bret M. Olson, White Lake, MI (US); Xingyong Song, Sterling Heights, MI (US); Farzad Samie, Franklin, MI (US); Edward N. Fuller, Austin, TX (US)

(73) Assignees: GM GLOBAL TECHNOLOGY OPERATIONS LLC, Detroit, MI (US); Microstaq Inc., Austin, TX (US)

(21) Appl. No.: 14/268,526

(22) Filed: May 2, 2014

(51) Int. Cl. F16K 31/02

(52) U.S. Cl. CPC F16K 31/02

(57) ABSTRACT

A method of controlling a Micro-Electro-Mechanical System (MEMS) valve includes defining a desired pressure output for the MEMS valve. The desired pressure output is related to a control reference value. The control reference value relates an output pressure of the MEMS valve to a measurable characteristic of the MEMS valve. The measurable characteristic may include a resistance, an electrical power, or an electrical current of the MEMS valve. The control reference value is converted to an initial Pulse Width Modulated (PWM) signal that is applied to the MEMS valve. The initial PWM signal may be adjusted to define an adjusted PWM signal based upon a difference between an actual value of the measurable characteristic at the initial PWM signal and the control reference value, until the actual value of the measurable characteristic at the adjusted PWM signal is within a pre-defined range of the control reference value.

### TECHNICAL FIELD

The invention generally relates to a method of controlling a Micro-Electro-Mechanical System (MEMS) valve used to control a hydraulically actuated device.

### BACKGROUND

Micro-Electro-Mechanical System (MEMS) valves are often used to control a hydraulically actuated device. A MEMS valve may be considered to include a class of systems that are physically small, having features with sizes in the micrometer range. A MEMS valve typically includes both electrical and mechanical components, and are typically actuated by an electrical signal, which produces a mechanical movement to control a fluid pressure output of the MEMS valve. The mechanical movement of the MEMS valve is controlled, based upon the electrical signal applied thereto, to control a desired fluid pressure output, which may be used to control and/or actuate the hydraulic device.

For example, a transmission of a vehicle may include several different hydraulic devices, such as clutches and/or brakes. The MEMS valve may be used to provide a desired pressure output for actuating and/or controlling the hydraulic devices. By varying the fluid pressure output of the MEMS valve, the actuation of the hydraulic devices may be controlled. As such, it is important to accurately control the fluid pressure output of the MEMS valve.

### SUMMARY

A method of controlling a Micro-Electro-Mechanical System (MEMS) valve is provided. The method includes defining a desired pressure output for the MEMS valve. The desired pressure output is related to a control reference value. The control reference value relates an output pressure of the MEMS valve to a measurable characteristic of the MEMS valve. The measurable characteristic of the MEMS valve may include, but is not limited to, a resistance of the MEMS valve, an electrical power of the MEMS valve, or an electrical current through the MEMS valve. The control reference value is converted to an initial Pulse Width Modulated (PWM) signal. The PWM signal is applied to the MEMS valve to control a position of the MEMS valve.

An actual value of the measurable characteristic of the MEMS valve at the initial PWM signal may be compared to the control reference value to define a difference between the actual value of the measurable characteristic of the MEMS valve at the initial PWM signal and the control reference value. The initial PWM signal may be adjusted to define an adjusted PWM signal based upon the difference between the actual value of the measurable characteristic of the MEMS valve at the initial PWM signal and the control reference value. The PWM signal may be adjusted until the actual value of the measurable characteristic of the MEMS valve at the adjusted PWM signal is within a pre-defined range of the control reference value.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic cross sectional view of a Micro-Electro-Mechanical System (MEMS) valve.

FIG. 2 is a schematic representation of a first control strategy for controlling the MEMS valve.

FIG. 3 is a schematic representation of a second control strategy for controlling the MEMS valve.

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the invention, as defined by the appended claims. Furthermore, the invention may be described herein in terms of functional and/or logical block components and/or various processing steps. It should be realized that such block components may be comprised of any number of hardware, software, and/or firmware components configured to perform the specified functions.

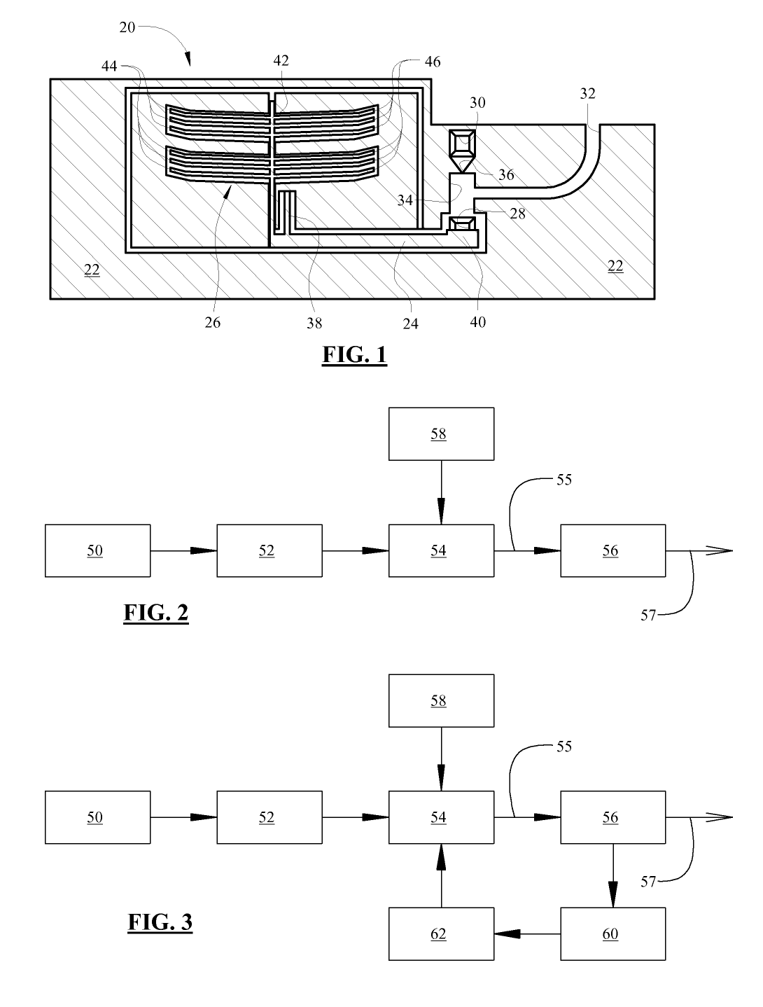

Referring to FIG. 1, wherein like reference numbers correspond to like or similar components, there is shown a schematic cross-sectional view of a Micro Electro Mechanical Systems (MEMS) pressure differential actuator valve, hereinafter referred to as a MEMS valve 20. As discussed herein, the MEMS valve 20 may be used to effect hydraulic control over one or more hydraulic devices, such as for example, within a transmission. The MEMS valve 20 that is shown is only one type of a MEMS device that may be used as a control valve or control actuator for the hydraulic device.

Generally, a MEMS device may be considered to include a class of systems that are physically small, having features with sizes in the micrometer range. MEMS devices may have both electrical and mechanical components. MEMS devices are produced through micromachining processes. The term “micromachining” generally refers to the production of three-dimensional structures and moving parts through processes including modified integrated circuit (computer chip) fabrication techniques (such as chemical etching) and materials (such as silicon semiconductor material). The term “MEMS valve 20” as used herein generally refers to a valve having internal components or features with sizes in the micrometer range, and thus by definition is at least partially formed by micromachining

Referring to FIG. 1, the MEMS valve 20 includes a housing or body 22. The MEMS valve 20 may be formed from several layers of material, such as several semi-conductor wafers. The body 22 may also be formed from multiple layers. For example, and without limitation, the cross-sectioned portions shown may be taken through a middle layer of the MEMS valve 20 to show the body 22, with two other layers existing behind and in front of (relative to the view in FIG. 1) the middle layer shown. The other layers of the body 22 may include solid covers, port plates, or electrical control plates. However each of the layers is generally considered part of the body 22, except where separately identified.

The MEMS valve 20 includes a beam 24 actuated by a valve actuator 26. Selective control of the actuator causes the beam 24 to selectively alter the flow of fluid between an inlet port 28 and an outlet port 30. By varying the fluid flow between the inlet port 28 and the outlet port 30, the MEMS valve 20 varies the pressure in a pilot port 32. As described herein, the pilot port 32 may be connected to additional valves or devices to effect hydraulic control thereof through a pilot signal which varies based upon the pressure in the pilot port 32.

The inlet port 28 is connected to a source of high-pressure fluid such as a transmission pump. The outlet port 30 is connected to a low-pressure reservoir or fluid return (not shown). For purposes of the description herein, the outlet port 30 may be considered to be at ambient pressure, and acts as a ground or zero state in the MEMS valve 20.

The beam 24 moves in a continuously variable manner between a first position, illustrated in FIG. 1, a second position (not shown), and myriad intermediate positions. In the first position, the beam 24 does not completely block the inlet port 28. However, in the second position, the beam 24 blocks the inlet port 28 to prevent substantially all flow from the high-pressure fluid source.

A first chamber 34 is in fluid communication with both the inlet port 28 and the outlet port 30. However, communication between the outlet port 30 and the first chamber 34 (and also the inlet port 28) is restricted by an outlet orifice 36. High volume or fast fluid flow through the outlet orifice 36 causes a pressure differential to build between the first chamber 34 and the outlet port 30.

The beam 24 is pivotally mounted to a fixed portion of the body 22 by a flexure pivot 38. The opposite portion of the beam 24 from the flexure pivot 38 is a movable end 40, which moves up and down (as viewed in FIG. 1) to selectively, and variably, cover and uncover the inlet port 28.

When the beam 24 is in the second position, it allows little or no flow from the inlet port 28 to the first chamber 34. Any pressurized fluid in the first chamber 34 bleeds off through the outlet orifice 36 to the outlet port 30. As the beam 24 of the MEMS valve 20 is moved toward the first (open) position, the inlet port 28 is progressively uncovered, allowing faster flows of fluid from the inlet port 28 into the first chamber 34. The fast-flowing fluid cannot all be drained through the outlet orifice 36 and causes a pressure differential to form as the fluid flows through the outlet orifice 36, raising pressure in the first chamber 34.

As the inlet port 28 is further opened to the first position (as shown in FIG. 1), fluid gradually flows faster through the outlet orifice 36, causing a larger pressure differential and further raising the pressure in the first chamber 34. When the beam 24 is in the first position, it allows high flow from the inlet port 28 to the first chamber 34. Therefore, the pressure in the first chamber 34 can be controlled by controlling the rate of flow from the inlet port 28 through the first chamber 34 and the outlet orifice 36 to the outlet port 30. The position of the beam 24 controls the rate of flow of the fluid from the inlet port 28, and thus the pressure in the first chamber 34.

The valve actuator 26 selectively positions the beam 24. The actuator includes an elongated spine 42 attached to the beam 24. The actuator further includes a plurality of first ribs 44 and a plurality of second ribs 46, which are generally located on opposing sides of the elongated spine 42. Each of the first ribs 44 has a first end attached to a first side of the elongated spine 42 and a second end attached to the body 22. Similar to the first ribs 44, each of the second ribs 46 has a first end attached to the elongated spine 42 and a second end attached to the fixed portion of the body 22.

The elongated spine 42 and the first ribs 44 and the second ribs 46 may appear illustrated in FIG. 1 as disconnected from the body 22. However, the elongated spine 42, the first ribs 44, and the second ribs 46 are formed from the same material and are connected to the body 22 at some point in order to allow relative movement. However, the connection may be below the cross-sectioned plane shown in FIG. 1. Generally, the elongated spine 42, the first ribs 44, and the second ribs 46 may be considered the moving portions of the valve actuator 26.

The first ribs 44 and the second ribs 46 are configured to thermally expand (elongate) and contract (shrink) in response to temperature changes within the first ribs 44 and the second ribs 46. Electrical contacts (not shown) are adapted for connection to a source of electrical power to supply electrical current flowing through the first ribs 44 and the second ribs 46 to thermally expand the first ribs 44 and the second ribs 46.

The valve actuator 26 is adapted to be controlled by an electronic control unit (ECU) or other programmable device (not shown) which supplies a Pulse Width Modulated (PWM) signal to the first ribs 44 and the second ribs 46. As the first ribs 44 and the second ribs 46 expand due to sufficient current flow, the elongated spine 42 moves or stretches downward (as viewed in FIG. 1), causing the beam 24 to rotate in the generally counter-clockwise direction. The resulting movement of the beam 24 causes the moveable end 40 to move upward (as viewed in FIG. 1) and progressively block more of the inlet port 28.

Closing the inlet port 28 allows less (and eventually no) fluid to flow into the first chamber 34, decreasing the pressure therein as the fluid drains to the outlet port 30. Once the inlet port 28 is closed, the MEMS valve 20 is in the second position (not shown), and no pilot signal is being communicated through the pilot port 32.

As the flow of current drops, the first ribs 44 and the second ribs 46 cool and contract. As the first ribs 44 and the second ribs 46 contract, the elongated spine 42 moves upward (as viewed in FIG. 1), causing the beam 24 to rotate in the generally clockwise direction. The resulting movement of the beam 24 causes the moveable end 40 to move downward (as viewed in FIG. 1) and progressively open more of the inlet port 28.

Opening the inlet port 28 allows more fluid to flow into the first chamber 34, increasing the pressure therein as the fluid flow overcomes the ability of the outlet port 30 to drain fluid from the first chamber 34. Once the inlet port 28 is substantially open, the MEMS valve 20 is in the first position (shown in FIG. 1), and a strong pilot signal is being communicated through the pilot port 32.

In addition to the resistively heat-actuated MEMS valve 20 shown in FIG. 1, other types of MEMS based valves may be used in place of the MEMS valve 20 or in place of the actuator. Accordingly, the MEMS valve 20 is only an exemplary embodiment of a MEMS based pressure differential actuator valve, and the scope of the claims is not limited to the exemplary embodiment of the MEMS valve 20 shown and described herein.

As described above, the output fluid pressure of the MEMS valve 20 is dependent upon the position of the moveable end 40 of the beam 24 relative to the inlet port 28. The position of the moveable end 40 is controlled by the valve actuator 26, which as noted above is controlled by resistive heating of the first ribs 44 and the second ribs 46. Accordingly, the valve actuator 26 must be accurately controlled in order to accurately control the output fluid pressure of the MEMS valve 20. A method of controlling the MEMS valve 20 is provided below. The method is based on the observation that the moveable end 40 of the beam 24 has a set position for any given temperature of the first ribs 44 and the second ribs 46, and that the temperature of the first ribs 44 and the second ribs 46 have a direct, one-to-one relationship with different measurable characteristics of the MEMS valve 20 and/or the valve actuator 26. The method described below may be embodied as a program operable on a control module, i.e., a MEMS controller (not shown). It should be appreciated that the control module may include any device capable of analyzing data from various sensors, comparing data, making the necessary decisions required to control the operation of the MEMS valve 20, and executing the required tasks necessary to control the operation of the MEMS valve 20.

Referring to FIG. 2, a first control strategy for controlling the MEMS valve 20 is generally shown. The method includes defining a desired pressure output (generally indicated by box 50) for the MEMS valve 20. The desired fluid pressure output for the MEMS valve 20 is based on several different factors, such as but not limited to, the specific hydraulic device being controlled. It should be appreciated that the desired fluid pressure output of the MEMS valve 20 corresponds to a position of the moveable end 40 of the beam 24, which corresponds to a temperature of the first ribs 44 and the second ribs 46 of the valve actuator 26.

Once the desired fluid pressure output is defined, the fluid pressure output is related to a control reference value (generally indicated by box 52). The control reference value relates the output pressure of the MEMS valve 20 to a measurable characteristic of the MEMS valve 20. The control reference value may include one of a resistance value, a power value, or a current value. The measurable characteristic of the MEMS valve 20 may include one of a resistance of the MEMS valve 20, an electrical power of the MEMS valve 20, or an electrical current through the MEMS valve 20. Accordingly, in order to achieve the desired fluid pressure output from the MEMS valve 20, the control reference value is defined to equal a value that is approximately equal to a value of the measureable characteristic of the MEMS valve 20 when the moveable head of the MEMS valve 20 is disposed in the appropriate position required to achieve the desired fluid pressure output.

The desired pressure output may be related to the control reference value by referencing a feed-forward look-up table, stored in a memory of the MEMS controller. The feed-forward look-up table provides a value for the control reference value, based on the desired pressure output of the MEMS valve 20. For example, if the measurable characteristic used to relate the control reference value to the desired fluid pressure output is the current applied to the MEMS valve 20, then the feed forward look-up table will provide a commanded current value, which approximates the current applied to the MEMS valve 20 when positioned to provide the desired fluid pressure output. The commanded current value may then be used to generate a control signal (generally indicated by box 54), which is applied to the MEMS valve 20 to control the actuation of the MEMS valve 20. Preferably, the control signal includes a Pulse Width Modulated (PWM) signal. However, it should be appreciated that the control signal may alternatively include some other form of signal, such as a voltage signal or a potential type signal. While the written specification hereinafter refers to the control signal as a PWM signal, the claims should not be so limited.

If the measurable characteristic used to relate the control reference value to the desired fluid pressure output is the resistance of the MEMS valve, then the feed forward look-up table will provide a commanded resistance value, which approximates the resistance of the MEMS valve 20 when positioned to provide the desired fluid pressure output. A potential difference, i.e., voltage, from a power supply of the MEMS valve 20, may be measured (generally indicated by box 58). The measured voltage of the power supply may then be divided by the commanded resistance value to calculate or define a commanded current value. The commanded current value may then be used to generate a PWM signal (generally indicated by box 54), which is applied to the MEMS valve 20 to control the actuation of the MEMS valve 20.

If the measurable characteristic used to relate the control reference value to the desired fluid pressure output is the power applied to the MEMS valve, then the feed forward look-up table will provide a commanded power value, which approximates the power of the MEMS valve 20 when positioned to provide the desired fluid pressure output. The commanded power value may be divided by the measured voltage of the power to calculate or define a commanded current value. The commanded current value may then be used to generate a PWM signal (generally indicated by box 54), which is applied to the MEMS valve 20 to control the actuation of the MEMS valve 20.

The PWM signal, generally indicated at 55, for controlling the MEMS valve 20, is generated (generally indicated by box 54), based on the commanded current value. As described above, if the measurable characteristic used to relate the control reference value to the desired fluid pressure output is the current applied to the MEMS valve 20, then the control reference value directly provides the commanded current value. However, if the measurable characteristic used to relate the control reference value to the desired fluid pressure output is the resistance of the MEMS valve 20, or the power applied to the MEMS value 20, then the control reference value is used to calculate or define the commanded current value. Accordingly, the control reference value is related to an initial PWM signal. The initial PWM signal 55 is the control signal that is applied to the MEMS valve 20 (generally indicated by box 56) to control the position of the MEMS valve 20. A controller, such as the MEMS controller, may be used to convert the control reference value into the initial PWM signal 55 as described above. As such, the initial PWM signal 55 heats the first ribs 44 and the second ribs 46 to a temperature that corresponds to the value of the control reference value associated with the required position of the MEMS valve 20 needed in order for the MEMS valve 20 to provide the desired fluid pressure output. The fluid pressure output from the MEMS valve 20 is generally indicated by arrow 57.

In order for the controller to define the initial PWM signal 55, the potential difference, i.e., a voltage, and the current from the power supply of the MEMS valve 20 must be known, and provided to the controller. Accordingly, the method includes sensing the potential difference of the power supply and the current through the MEMS valve 20 (generally indicated by box 58). The potential difference and the current of the MEMS power supply may be sensed and/or determined in any suitable manner, and used as described above to define the commanded current value.

Referring to FIG. 3, a second control strategy for controlling the MEMS valve 20 is generally shown. The second control strategy, shown in FIG. 3, differs from the first control strategy, shown in FIG. 2, in that the second control strategy includes a feedback loop to more precisely control the MEMS valve 20. Processes of the first control strategy that are similar to those of the second control strategy are shown in FIG. 3 with the same reference numerals used in FIG. 2.

Once the initial PWM signal 55 is applied to the MEMS valve 20, an actual value of the measurable characteristic of the MEMS valve 20 at the initial PWM signal 55 is sensed and provided to the controller (generally indicated by box 60). The actual value of the measurable characteristic of the MEMS valve 20 at the initial PWM signal 55 is compared to the control reference value (generally indicated by box 62) to define a difference between the actual value of the measurable characteristic of the MEMS valve 20 at the initial PWM signal 55 and the control reference value. It should be appreciated that due to many different variables, such as but not limited to, the ambient temperature of the MEMS valve 20, and/or fluctuations in the voltage and/or current of the MEMS valve 20 power supply, that the initial PWM signal 55 may not heat the valve actuator 26 of the MEMS valve 20 to the exact temperature that corresponds to the desired fluid pressure output of the MEMS valve 20. In order to correct for such a variation, the initial PWM signal 55 is adjusted or re-defined (generally indicated by box 54) to define an adjusted PWM signal 55. The initial PWM signal 55 is adjusted based upon the difference between the actual value of the measurable characteristic of the MEMS valve 20 at the initial PWM signal 55 and the control reference value. The adjusted PWM signal 55 is then applied to the MEMS valve 20. Accordingly, it should be appreciated that the controller applies the initial PWM signal 55 to the MEMS valve 20, and then adjusts or re-defines the PWM signal 55 and then applies the adjusted PWM signal 55. The PWM signal 55 may be continuously and/or occasionally adjusted until the actual value of the measurable characteristic of the MEMS valve 20 at the adjusted PWM signal 55 is within a pre-defined range of the control reference value. The pre-defined range of the control reference value may be defined to include any acceptable and/or tolerable variation in the fluid pressure output of the MEMS valve 20.

For example, when the MEMS valve 20 is to be controlled based upon the resistance of the MEMS valve 20, and the control reference value is defined by a resistance value, then the controller calculates or measures an actual resistance of the MEMS valve 20 with the initial PWM signal 55 applied thereto. The actual resistance of the MEMS valve 20 may be calculated by dividing the potential difference of the MEMS valve 20 by the current applied to the MEMS valve 20. The controller may then compare the actual resistance of the MEMS valve 20 at the initial PWM signal 55, to the resistance value of the control reference value, to define the difference between the actual resistance of the MEMS valve 20 at the initial PWM signal 55 and the resistance value of the control reference value. The initial PWM signal 55 is adjusted to define the adjusted PWM signal 55 based upon the difference between the actual resistance of the MEMS valve 20 at the initial PWM signal 55 and the resistance value of the control reference value. The PWM signal 55 may be adjusted until the actual resistance of the MEMS valve 20 at the adjusted PWM signal 55 is within a pre-defined range of the resistance value of the control reference value. For example, assuming that the desired fluid pressure output for the MEMS valve 20 relates to resistance of the MEMS valve 20 that is equal to 28 ohms, then the resistance value of the control reference value is defined as 28 ohms. The initial PWM signal 55 is defined to achieve the 28 ohm resistance in the MEMS valve 20. However, if the actual resistance of the MEMS valve 20 is equal to 27 ohms, then the initial PWM signal 55 is adjusted until the actual resistance of the MEMS valve 20 is substantially equal to 28 ohms.

In another example, when the MEMS valve 20 is to be controlled based upon the power of the MEMS valve 20, and the control reference value is defined by a power value, then the controller calculates or measures an actual power of the MEMS valve 20 with the initial PWM signal 55 applied thereto. The actual power of the MEMS valve 20 may be calculated by multiplying the potential difference of the MEMS valve 20 by the current applied to the MEMS valve 20. The controller may then compare the actual power of the MEMS valve 20 at the initial PWM signal 55, to the power value of the control reference value, to define the difference between the actual power of the MEMS valve 20 at the initial PWM signal 55 and the power value of the control reference value. The initial PWM signal 55 is adjusted to define the adjusted PWM signal 55 based upon the difference between the actual power of the MEMS valve 20 at the initial PWM signal 55 and the power value of the control reference value. The PWM signal 55 may be adjusted until the actual power of the MEMS valve 20 at the adjusted PWM signal 55 is within a pre-defined range of the power value of the control reference value. For example, assuming that the desired fluid pressure output for the MEMS valve 20 relates to a power of the MEMS valve 20 that is equal to 6.25 watts, then the power value of the control reference value is defined as 6.25 watts. The initial PWM signal 55 is defined to achieve the 6.25 watts power in the MEMS valve 20. However, if the actual power of the MEMS valve 20 is equal to 6 watts, then the initial PWM signal 55 is adjusted until the actual resistance of the MEMS valve 20 is substantially equal to 6.25 watts.

The detailed description and the drawings or figures are supportive and descriptive of the invention, but the scope of the invention is defined solely by the claims. While some of the best modes and other embodiments for carrying out the claimed invention have been described in detail, various alternative designs and embodiments exist for practicing the invention defined in the appended claims.

1. A method of controlling a Micro-Electro-Mechanical System (MEMS) valve, the method comprising:
defining a desired pressure output for the MEMS valve;
relating the desired pressure output to a control reference value, wherein the control reference value relates an output pressure of the MEMS valve to a measurable characteristic of the MEMS valve;
converting the control reference value to an initial control signal; and
applying the initial control signal to the MEMS valve to control a position of the MEMS valve.

2. The method set forth in claim 1 wherein the measurable characteristic includes one of a resistance of the MEMS valve, an electrical power of the MEMS valve, or an electrical current through the MEMS valve.

3. The method set forth in claim 2 wherein the control reference value includes one of a resistance value, a power value, or a current value.

4. The method set forth in claim 1 wherein relating the desired pressure output to the control reference value includes referencing a feed-forward look-up table.

5. The method set forth in claim 1 further comprising comparing an actual value of the measurable characteristic of the MEMS valve at the initial control signal, to the control reference value to define a difference between the actual value of the measurable characteristic of the MEMS valve at the initial control signal and the control reference value.

6. The method set forth in claim 5 further comprising adjusting the initial control signal to define an adjusted control signal based upon the difference between the actual value of the measurable characteristic of the MEMS valve at the initial control signal and the control reference value, until the actual value of the measurable characteristic of the MEMS valve at the adjusted control signal is within a pre-defined range of the control reference value.

7. The method set forth in claim 1 further comprising calculating an actual resistance of the MEMS valve with the initial control signal applied thereto.

8. The method set forth in claim 7 wherein calculating the actual resistance of the MEMS valve includes dividing a potential difference of the MEMS valve by a current applied to the MEMS valve.

9. The method set forth in claim 8, wherein the control reference value includes a resistance value, and wherein the method further comprises comparing the actual resistance of the MEMS valve at the initial control signal, to the resistance value of the control reference value to define a difference between the actual resistance of the MEMS valve at the initial control signal and the resistance value of the control reference value.

10. The method set forth in claim 9 further comprising adjusting the initial control signal to define an adjusted control signal based upon the difference between the actual resistance of the MEMS valve at the initial control signal and the resistance value of the control reference value, until the actual resistance of the MEMS valve at the adjusted control signal is within a pre-defined range of the resistance value of the control reference value.

11. The method set forth in claim 1 further comprising calculating an actual power of the MEMS valve with the initial control signal applied thereto.

12. The method set forth in claim 11 wherein calculating the actual power of the MEMS valve includes multiplying a potential difference of the MEMS valve by a current applied to the MEMS valve.

13. The method set forth in claim 12, wherein the control reference value includes a power value, and wherein the method further comprises comparing the actual power of the MEMS valve at the initial control signal, to the power value of the control reference value to define a difference between the actual power of the MEMS valve at the initial control signal and the power value of the control reference value.

14. The method set forth in claim 13 further comprising adjusting the initial control signal to define an adjusted control signal based upon the difference between the actual power of the MEMS valve at the initial control signal and the power value of the control reference value, until the actual power of the MEMS valve at the adjusted control signal is within a pre-defined range of the power value of the control reference value.

15. A method as set forth in claim 1 wherein the control signal is a Pulse Width Modulated (PWM) signal.

16. A method of controlling a Micro-Electro-Mechanical System (MEMS) valve, the method comprising:
defining a desired pressure output for the MEMS valve;
relating the desired pressure output to a resistance value;
converting the resistance value to an initial Pulse Width Modulated (PWM) signal; and
applying the initial PWM signal to the MEMS valve to control a position of the MEMS valve.

17. The method set forth in claim 16 further comprising comparing an actual resistance of the MEMS valve at the initial PWM signal, to the resistance value to define a difference between the actual resistance of the MEMS valve at the initial PWM signal and the resistance value.

18. The method set forth in claim 17 further comprising adjusting the initial PWM signal to define an adjusted PWM signal based upon the difference between the actual resistance of the MEMS valve at the initial PWM signal and the resistance value, until the actual resistance of the MEMS valve at the adjusted PWM signal is within a pre-defined range of the resistance value.

19. A method of controlling a Micro-Electro-Mechanical System (MEMS) valve, the method comprising:
defining a desired pressure output for the MEMS valve;
relating the desired pressure output to a power value;
converting the power value to an initial Pulse Width Modulated (PWM) signal; and
applying the initial PWM signal to the MEMS valve to control a position of the MEMS valve.

20. The method set forth in claim 19 further comprising:
comparing an actual power of the MEMS valve at the initial PWM signal, to the power value to define a difference between the actual power of the MEMS valve at the initial PWM signal and the power value; and
adjusting the initial PWM signal to define an adjusted PWM signal based upon the difference between the actual power of the MEMS valve at the initial PWM signal and the power value, until the actual power of the MEMS valve at the adjusted PWM signal is within a pre-defined range of the power value.
